(19) United States
(12) Patent Application Publication
(10) Pub. No.: US 2022/0027767 A1
(43) Pub. Date: Jan. 27, 2022

(54) SYSTEM FOR COGNITIVE RESOURCE IDENTIFICATION USING SWARM INTELLIGENCE

(71) Applicant: BANK OF AMERICA CORPORATION, Charlotte, NC (US)

(72) Inventor: Madhusudhanan Krishnamoorthy, Hasthinapuram (IN)

(73) Assignee: BANK OF AMERICA CORPORATION, Charlotte, NC (US)

(21) Appl. No.: 16/935,323

(22) Filed: Jul. 22, 2020

(51) Int. Cl. G06N 5/04

(52) U.S. Cl. CPC G06N 5/043

(57) ABSTRACT

Systems, computer program products, and methods are described herein for cognitive resource identification using swarm intelligence. The present invention is configured to receive one or more resource requirements; receive metadata associated with one or more resources; generate a superimposed unified resource ontological (URO) graph based on at least the resource requirements and the metadata associated with the resources; initiate an ant colony optimization (ACO) algorithm on the superimposed URO graph; generate, using the ACO algorithm, one or more primary resource selection parameters; initiate a fuzzy resource selection engine on the primary resource selection parameters; determine the resources in a descending order of applicability for the resource requirements; and transmit control signals configured to cause the computing device of the user to display the resources in the descending order of applicability to the resource requirements.

### FIELD OF THE INVENTION

The present invention embraces a system for cognitive resource identification using swarm intelligence.

### BACKGROUND

By giving developers access to well-built components that serve important functions in the context of wider applications, the open source model speeds up development times for commercial resources by making it unnecessary to build entire resource suites completely from scratch. However, identifying the right resources may prove to be challenging owing to various dependency issues, exposure factors and data leakage factors.

There is a need for a system for cognitive resource identification using swarm intelligence.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for cognitive resource identification using swarm intelligence is presented. The system comprising: at least one non-transitory storage device; and at least one processing device coupled to the at least one non-transitory storage device, wherein the at least one processing device is configured to: electronically receive, from a computing device of a user, one or more resource requirements associated with an entity; electronically receive metadata associated with one or more resources; generate a superimposed unified resource ontological (URO) graph based on at least the one or more resource requirements and the metadata associated with the one or more resources; initiate an ant colony optimization (ACO) algorithm on the superimposed URO graph; generate, using the ACO algorithm, one or more primary resource selection parameters based on at least initiating the ACO algorithm on the superimposed URO graph; initiate a fuzzy resource selection engine on the one or more primary resource selection parameters; determine, using the fuzzy resource selection engine, the one or more resources in a descending order of applicability for the one or more resource requirements based on at least the one or more primary resource selection parameters; and transmit control signals configured to cause the computing device of the user to display the one or more resources in the descending order of applicability to the one or more resource requirements.

In some embodiments, the at least one processing device is further configured to: determine one or more exposure requirements associated with the entity; initiate one or more machine learning algorithms on the one or more resource requirements and the one or more exposure requirements; and generate a URO graph for the one or more resource requirements, wherein the URO graph for the one or more resource requirements comprises one or more nodes representing the one or more resource requirements and one or more edges representing the one or more exposure requirements.

In some embodiments, the at least one processing device is further configured to: electronically receive metadata associated with the one or more resources, wherein the metadata further comprises at least one or more exposure factors associated with the one or more resources, one or more dependencies associated with the one or more resources, and one or more data leakages associated with the one or more resources.

In some embodiments, the at least one processing device is further configured to: initiate the one or more machine learning algorithms on the metadata associated with the one or more resources; generate a URO graph for the one or more resources, wherein the URO graph for the one or more resources comprises one or more nodes representing information associated with the one or more resources, and one or more edges representing the one or more exposure factors associated with each of the one or more resources, the one or more dependencies associated with each of the one or more resources, and the one or more data leakages associated with each of the one or more resources.

In some embodiments, the at least one processing device is further configured to: generate the superimposed URO graph based on at least the URO graph for the one or more resource requirements and the URO graph for the one or more resources, wherein the superimposed URO graph is fully connected.

In some embodiments, the at least one processing device is further configured to: initiate the ant colony optimization (ACO) algorithm on the superimposed URO graph, wherein initiating further comprises: traversing, iteratively, the superimposed URO graph, wherein traversing further comprises traversing one or more paths from the one or more nodes representing the one or more resource requirements to the one or more nodes representing the information associated with the one or more resources; and generating one or more pheromone trail values for the one or more paths at each iteration.

In some embodiments, the at least one processing device is further configured to: generate the one or more primary resource selection parameters based on at least the one or more pheromone trail values.

In some embodiments, the one or more primary resource selection parameters comprises at least path preference parameters, exposure preference parameters, and resource preference parameters.

In some embodiments, the at least one processing device is further configured to: generate one or more secondary resource selection parameters based on at least the one or more pheromone trail values; transmit the one or more secondary resource selection parameters to a computing device associated with a subject matter expert (SME); electronically receive, from the computing device associated with the SME, one or more SME inputs based on at least the one or more secondary resource selection parameters; and determine, using the fuzzy resource selection engine, the one or more resources in the descending order of applicability for the one or more resource requirements based on at least the one or more primary resource selection parameters and the one or more SME inputs.

In another aspect, a computer program product for cognitive resource identification using swarm intelligence is presented. The computer program product comprising a non-transitory computer-readable medium comprising code causing a first apparatus to: electronically receive, from a computing device of a user, one or more resource requirements associated with an entity; electronically receive metadata associated with one or more resources; generate a superimposed unified resource ontological (URO) graph based on at least the one or more resource requirements and the metadata associated with the one or more resources; initiate an ant colony optimization (ACO) algorithm on the superimposed URO graph; generate, using the ACO algorithm, one or more primary resource selection parameters based on at least initiating the ACO algorithm on the superimposed URO graph; initiate a fuzzy resource selection engine on the one or more primary resource selection parameters; determine, using the fuzzy resource selection engine, the one or more resources in a descending order of applicability for the one or more resource requirements based on at least the one or more primary resource selection parameters; and transmit control signals configured to cause the computing device of the user to display the one or more resources in the descending order of applicability to the one or more resource requirements.

In yet another aspect, a method for cognitive resource identification using swarm intelligence is presented. The method comprising: electronically receiving, from a computing device of a user, one or more resource requirements associated with an entity; electronically receiving metadata associated with one or more resources; generating a superimposed unified resource ontological (URO) graph based on at least the one or more resource requirements and the metadata associated with the one or more resources; initiating an ant colony optimization (ACO) algorithm on the superimposed URO graph; generating, using the ACO algorithm, one or more primary resource selection parameters based on at least initiating the ACO algorithm on the superimposed URO graph; initiating a fuzzy resource selection engine on the one or more primary resource selection parameters; determining, using the fuzzy resource selection engine, the one or more resources in a descending order of applicability for the one or more resource requirements based on at least the one or more primary resource selection parameters; and transmitting control signals configured to cause the computing device of the user to display the one or more resources in the descending order of applicability to the one or more resource requirements.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for cognitive resource identification using swarm intelligence, in accordance with an embodiment of the invention;

FIG. 2 illustrates a process flow of a system for cognitive resource identification using swarm intelligence, in accordance with an embodiment of the invention; and

FIG. 3 illustrates a block diagram of a system for cognitive resource identification using swarm intelligence, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, a “resource” may generally refer to objects, software (e.g., open source), hardware products, devices, goods, commodities, services, and the like, and/or the ability and opportunity to access and use the same. Some example implementations herein contemplate executable computer program code comprising a collection of data or computer instructions configured to execute a specific set of actions and/or satisfy a resource requirement. In some example implementations, a resource may be a computer program code written in a specific programming language such as Java, Python, R, or the like.

As used herein, a “resource requirement” may refer to a condition or capability needed to solve a problem or achieve an objective. In some example implementations, resource requirements may be written text describing capabilities, functions, and constraints associated with a system or system component. In some embodiments, a resource requirement may include two components: exposure requirements and objective/functional requirements. In one aspect, exposure requirements may include one or more conditions or capabilities that must be met or possessed by a system or system component to satisfy a contract, standard, specification, or other formally imposed requirement. In one aspect objective/functional requirements may define the system or system component. It describes the functions a software must perform and helps capture the intended behavior of the system.

As used herein, “authentication credentials” may be any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

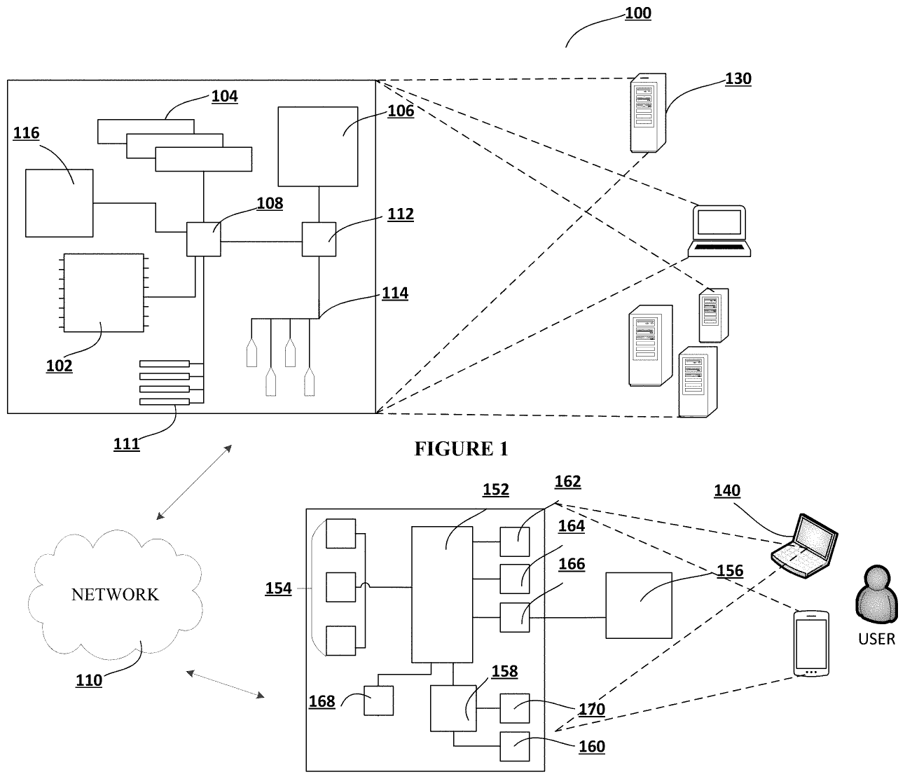

FIG. 1 presents an exemplary block diagram of the system environment for cognitive resource identification using swarm intelligence 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute resource transfers using one or more applications stored thereon. The one or more applications may be configured to communicate with the system 130, execute a transaction, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, personal digital assistants, servers, blade servers, mainframes, and other appropriate computers. The user input system 140 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application, and allows memory reuse for better utilization of the memory resources when the data sizes are large.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation- and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

By giving developers access to well-built components that serve important functions in the context of wider applications, the open source model speeds up development times for commercial resources by making it unnecessary to build entire resource suites completely from scratch. However, identifying the right resources may prove to be challenging owing to various dependency issues, exposure factors and data leakage factors. The present invention provides the functional benefit of using ant colony optimization (ACO) algorithm on a superimposed URO graph reflecting the resource requirements and the available resources. The URO graph for the resource requirements are weighted by the exposure requirements while the URO graph for the resources are weighted by exposure factors, dependencies, and data leakages for each resource. The ACO algorithm is configured to traverse the paths in the superimposed URO graph and identify a set of paths with the shortest distance (weighted) between the nodes representing the resource requirements and the nodes representing the resources. Each path is characterized by a set of primary resource selection parameters (path preference parameters, exposure preference parameters, and resource preference parameters) and secondary resource selection parameters (SME input). These characterizations are then fed into a fuzzy resource selection engine which determines the resources in a descending order of applicability for the resource requirements based on at least the primary resource selection parameters and the secondary selection parameters.

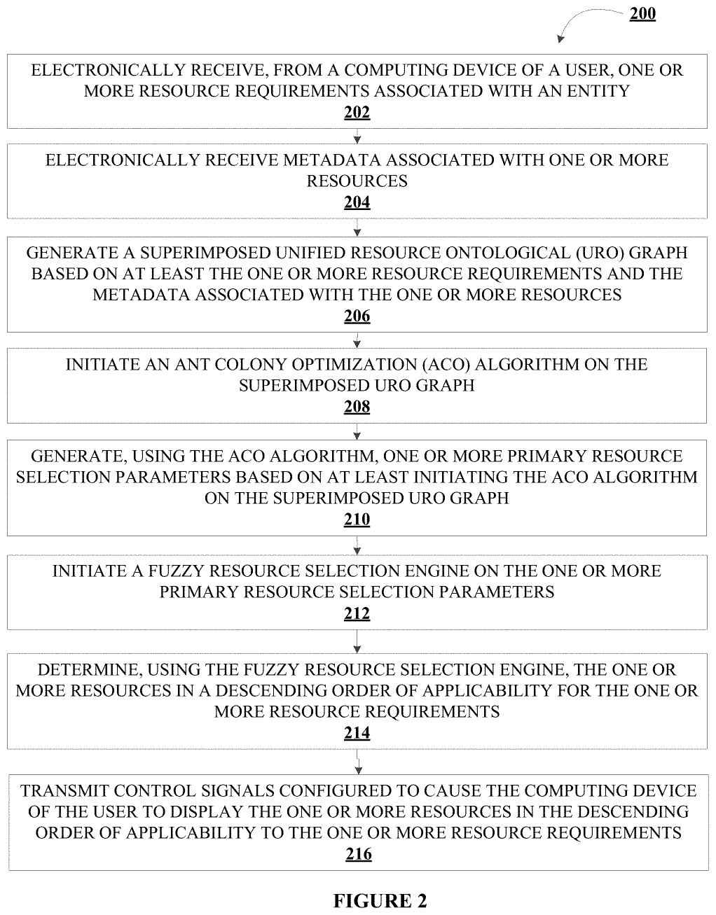

FIG. 2 illustrates a process flow of a system for cognitive resource identification using swarm intelligence 200, in accordance with an embodiment of the invention. As shown in block 202, the process flow includes electronically receiving, from a computing device of a user, one or more resource requirements associated with an entity. As described herein, the one or more resource requirements may be a condition or capability needed to solve a problem or achieve an objective associated with an entity. Each resource requirement may be associated with one or more exposure requirements implemented by the entity. In some embodiments, the exposure requirements may be regulatory functions imposing requirements, conditions or restrictions, standards imposed by a regulatory body (also functional agency, regulatory authority, or regulator) responsible for exercising autonomous authority over some functions of an entity in a supervisory capacity. In some other embodiments, the exposure requirements may be standards imposing technology requirements, metrics, and standards to drive innovation and economic competitiveness in the science and technology industry, security control guidelines for protecting information and information systems. In yet another embodiments, the exposure requirements may be frameworks promoted by non-profit organizations to promote the use of best practices for providing security assurance within specific service areas such cloud computing, and to provide education on the uses of the services. In still other embodiments, the exposure requirements may be internal standards imposing requirements, conditions or restrictions, standards imposed by an internal sub-entity responsible for maintaining authority over at least a portion of functions of each sub-entity in a supervisory capacity. Therefore, for each resource requirement to be met, the resources used must meet the exposure requirements. In one aspect, each resource requirement may require a portion of the exposure requirements to be met.

In response, the system may be configured to initiate one or more machine learning algorithms on the one or more resource requirements. In some embodiments, the system may be configured to implement any of the following applicable machine learning algorithms either singly or in combination: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. In some embodiments, the one or more machine learning algorithms may include convolutional neural networks (CNNs). By implementing CNNs, either singly or in combination with any of the other machine learning algorithms, the interactions of the user can be represented in the form of images and using CNNs, a visual flow of the interaction can be created. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) can be used in generating the relevant knowledge graph (discussed in more detail below) to the system 130.

In some embodiments, due to the nature of the resource requirements, the structural information associated with the one or more resource requirements may be unstructured. In other words, the one or more resource requirement either does not have a pre-defined data model or is not organized in a pre-defined manner. By implementing the one or more machine learning algorithms on the one or more requirements, the system may be configured to identify contextual and relational information between the one or more resource requirements and contextual and relational information between the one or more resource requirements and the one or more exposure requirements. To this end, the system may be configured to implement machine learning algorithms capable of natural language processing to derive meaning from human language in smart and useful ways to perform tasks such as automatic summarization, translation, named entity recognition, relationship extraction, sentiment analysis, speech recognition, and topic segmentation. By implementing such algorithms, the system may be configured to generate secondary or derivative datasets by identifying and analyzing any contextual and/or relational information present in the resource requirements.

In response to generating the secondary or derivative datasets, the system may be configured to generate a uniform resource ontological (URO) graph for the one or more resource requirements. In one aspect, the URO graph may be a set of datapoints linked by common information (such as contextual and/or relational information) that describes the resource requirements. In some embodiments, the URO graph for the one or more resource requirements may be generated by linking the data together combining both node level information and edge level information. Accordingly, the system may be configured to generate a URO graph for the one or more resource requirements with one or more nodes representing the one or more resource requirements and one or more edges representing the one or more exposure requirements. Embodiments where the nodes represent the resource requirements and the edges represent the exposure requirements are exemplary, and various other forms of URO graphs are applicable. For example, the resource requirements and the exposure requirements may each have their own URO graphs which may then be superimposed to form a graph representing the overall requirements.

Next, as shown in block 204, the process flow includes electronically receiving metadata associated with one or more resources. In some embodiments, the metadata associated with the one or more resources may include descriptive information associated with the one or more resources. Such information may be used for discovery and identification. In some other embodiments, the metadata associated with the one or more resources may include structural information describing how the resources are hierarchically structured. In still other embodiments, the metadata associated with the one or more resources may include administrative information used to manage the resource, such as resource type, permissions, and when and how it was created and typically used. In yet another embodiment, the metadata associated with the one or more resources may include statistical information or process data that may describe the processes that collect, process, or produce statistical data. In addition, the metadata associated with the one or more resources may include at least one or more exposure factors associated with the one or more resources, one or more dependencies associated with the one or more resources, and one or more data leakages associated with the one or more resources. In some embodiments, the one or more exposure factors may include information associated with the existence of any exposure, the possibility of an unauthorized person to gain access to the exposure, and the capability of the unauthorized person to gain access to the exposure via tools or with certain techniques. In some embodiments, the one or more dependencies may indicate the degree to which each resource (code portion) may be reliant on one of the other resources. In some embodiments, the one or more data leakages may be any unauthorized transmission of data from a resource to an external recipient.

In some embodiments, the system may be configured to initiate the one or more machine learning algorithms on the metadata associated with the one or more resources. In response, the system may be configured to generate a URO graph for the one or more resources, similar to the process used to generate the URO graph for the resource requirements described herein. In some embodiments, the URO graph for the one or more resources may include one or more nodes representing information associated with the one or more resources, and one or more edges representing the one or more exposure factors associated with each of the one or more resources, the one or more dependencies associated with each of the one or more resources, and the one or more data leakages associated with each of the one or more resources.

Next, as shown in block 206, the process flow includes generating a superimposed unified resource ontological (URO) graph based on at least the one or more resource requirements and the metadata associated with the one or more resources. In some embodiments, the system may be configured to generate the superimposed URO graph based on at least the URO graph for the one or more resource requirements and the URO graph for the one or more resources. In one aspect, the superimposed URO graph is fully connected, i.e., it's possible to get from every node in the graph to every other node in the graph through a series of edges, called a path.

Next, as shown in block 208, the process flow includes initiating ant colony optimization (ACO) algorithm on the superimposed URO graph. ACO algorithm is a probabilistic, population-based metaheuristic technique for solving computational problems which can be reduced to finding good paths through graphs. In ACO, a set of software agents called artificial ants search for good solutions to a given optimization problem. To apply ACO, the optimization problem is transformed into the problem of finding the best path on a weighted graph, such as the superimposed URO graph. The artificial ants (hereafter ants) incrementally build solutions by moving from one node to another on the graph. The solution construction process is stochastic and is biased by a pheromone model, that is, a set of parameters associated with graph components (either nodes or edges) whose values are modified at runtime by the ants. For purposes of this invention, the optimization problem is transformed into the problem of finding the shortest distance between resource requirements and the resources, where the resource requirements are weighted by the exposure requirements associated with the entity and resources are weighted by the exposure factors, data leakages, and dependencies associated with the resources.

In our model, the graph G=(V, E), where V consists of two sets of nodes, Rr represents various resource requirements, Rr1, Rr2, . . . Rrn (representing the nest of the ants), and R represents the various resources, R1, R2, . . . Rn (food source). Furthermore, E consists of various paths, namely, e1, e2, . . . en from Rr1, Rr2, . . . Rrn to R1, R2, . . . Rn. Real ants deposit pheromones on the paths on which they move. These chemical pheromones are modelled as t1, t2, . . . to for each path, e1, e2, . . . en. Such a value indicates the strength of the pheromone trail on the corresponding path.

In some embodiments, by initiating the ACO algorithm, the system may be configured to traverse, iteratively, the superimposed URO graph. In this regard, the system may be configured to traverse one or more paths from the one or more nodes representing the one or more resource requirements to the one or more nodes representing the information associated with the one or more resources. In doing so, the system may be configured to generate one or more pheromone trail values for the one or more paths at each iteration. At each iteration, the paths between nodes with shorter distances have higher pheromone trail values while the paths between nodes with longer distances have lower pheromone trail values, thus converging to a set of paths that may have the shortest distances between the resource requirements and the resources. In some embodiments, the distance, or geodesic distance between weighted nodes in the superimposed URO graph may be calculated using similarity measures including, but not limited to, Katz index, Euclidean commute-time distance, SimRank similarity measure, exponential diffusion kernel, Laplacian exponential diffusion kernel, Markov diffusion distance, and/or the like. In some embodiments, these set of paths may be characterized by the nature of the weights associated with them.

Next, as shown in block 210, the process flow includes generating, using the ACO algorithm, one or more primary resource selection parameters based on at least initiating the ACO algorithm on the superimposed URO graph. In one aspect the primary resource selection parameters may be used to characterize the set of paths between the resource requirements and the resources identified using the ACO algorithm. In some embodiments, the one or more primary resource selection parameters may include at least path preference parameters, exposure preference parameters, and resource preference parameters. In some embodiments, the path preference parameters may be used to indicate how often the resource is used and the frequency of its utilization to meet other same or similar resource requirements. In some other embodiments, the exposure preference parameters may be used to compare the exposure factors associated with the resources with the exposure requirements associated with the entity to determine a fit. In still other embodiments, the resource preference parameters may be used to determine whether any of the resource have previously been used to meet any previous resource requirements or are currently being used to meet any previous resource requirements, and its overall fit with the resource requirements. As described herein, the one or more primary resource selection parameters may be generated based on at least the one or more pheromone trail values.

In some embodiments, the system may be configured to generate one or more secondary resource selection parameters based on at least the one or more pheromone trail values. In response, the system may be configured to transmit the one or more secondary resource selection parameters to a computing device associated with a subject matter expert (SME). In response, the system may be configured to electronically receive, from the computing device associated with the SME, one or more SME inputs based on at least the one or more secondary resource selection parameters.

Next, as shown in block 212, the process flow includes initiating a fuzzy resource selection engine on the one or more primary resource selection parameters. In some embodiments, the fuzzy resource selection engine may be used to analyze analog input values in terms of logical variables that take on continuous values between 0 and 1. In this way, the fuzzy resource selection engine may use the primary and secondary resource selection parameters and map each path associated with the set of paths a continuous variable between 0 and 1, thereby providing an improved stochastic modeling capability. As each path is a link between a resource requirement and a resource, a path with a higher value (closer to 1) indicates that the resource linked to the resource requirement is a good fit. Similarly, a path with a lower value (closer to 1) indicates that the resource linked to the resource requirement is not a good fit.

Next, as shown in block 214, the process flow includes determining, using the fuzzy resource selection engine, the one or more resources in a descending order of applicability (or fit) for the one or more resource requirements based on at least the one or more primary resource selection parameters. In some embodiments, the system may be configured to determine, using the fuzzy resource selection engine, the one or more resources in the descending order of applicability for the one or more resource requirements based on at least the one or more primary resource selection parameters and the one or more SME inputs.

Next, as shown in block 216, the process flow includes transmitting control signals configured to cause the computing device of the user to display the one or more resources in the descending order of applicability to the one or more resource requirements. In response to receiving the one or more resources, the system may be configured to automatically implement the one or more resources. In some other embodiments, the system may be configured to receive a user input selecting at least one of the one or more resources to be implemented to satisfy the resource requirements. In response to receiving the user input, the system may be configured to implement the resources selected by the user.

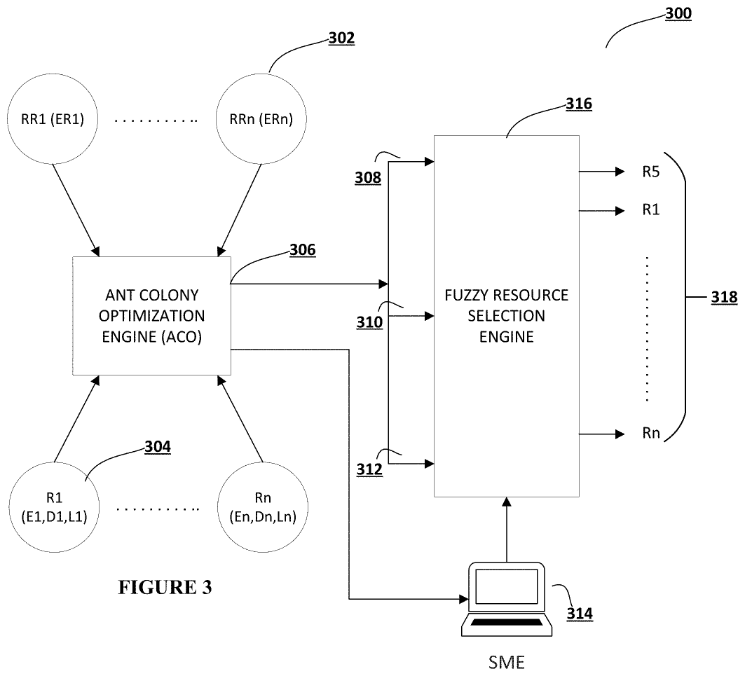

FIG. 3 illustrates a block diagram of a system for cognitive resource identification using swarm intelligence 300, in accordance with an embodiment of the invention. As shown in FIG. 3, the system may be configured to initiate the ACO algorithm 306 on the superimposed URO graph that comprises the URO graph for the resource requirements 302 and the URO graph for the resources 304. In response, the ACO algorithm generates primary selection preference parameters comprising path preference parameters 308, exposure preference parameters 310, and resource preference parameters 312. In addition to generating the primary selection preference parameters, the ACO algorithm also generates the secondary selection preference parameters 314. Both the primary selection preference parameters and the secondary selection preference parameters are then fed into the fuzzy resource selection engine 316. In response, the fuzzy resource selection engine 316 generates an order for a set of resources 318 with that fit the needs of the one or more resource requirements and the one or more exposure requirements.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for cognitive resource identification using swarm intelligence, the system comprising:
at least one non-transitory storage device; and
at least one processing device coupled to the at least one non-transitory storage device, wherein the at least one processing device is configured to:
electronically receive, from a computing device of a user, one or more resource requirements associated with an entity;
electronically receive metadata associated with one or more resources;
generate a superimposed unified resource ontological (URO) graph based on at least the one or more resource requirements and the metadata associated with the one or more resources;
initiate an ant colony optimization (ACO) algorithm on the superimposed URO graph;
generate, using the ACO algorithm, one or more primary resource selection parameters based on at least initiating the ACO algorithm on the superimposed URO graph;
initiate a fuzzy resource selection engine on the one or more primary resource selection parameters;
determine, using the fuzzy resource selection engine, the one or more resources in a descending order of applicability for the one or more resource requirements based on at least the one or more primary resource selection parameters; and
transmit control signals configured to cause the computing device of the user to display the one or more resources in the descending order of applicability to the one or more resource requirements.

2. The system of claim 1, wherein the at least one processing device is further configured to:
determine one or more exposure requirements associated with the entity;
initiate one or more machine learning algorithms on the one or more resource requirements and the one or more exposure requirements; and
generate a URO graph for the one or more resource requirements, wherein the URO graph for the one or more resource requirements comprises one or more nodes representing the one or more resource requirements and one or more edges representing the one or more exposure requirements.

3. The system of claim 2, wherein the at least one processing device is further configured to:
electronically receive metadata associated with the one or more resources, wherein the metadata further comprises at least one or more exposure factors associated with the one or more resources, one or more dependencies associated with the one or more resources, and one or more data leakages associated with the one or more resources.

4. The system of claim 3, wherein the at least one processing device is further configured to:
initiate the one or more machine learning algorithms on the metadata associated with the one or more resources; and
generate a URO graph for the one or more resources, wherein the URO graph for the one or more resources comprises one or more nodes representing information associated with the one or more resources, and one or more edges representing the one or more exposure factors associated with each of the one or more resources, the one or more dependencies associated with each of the one or more resources, and the one or more data leakages associated with each of the one or more resources.

5. The system of claim 4, wherein the at least one processing device is further configured to:
generate the superimposed URO graph based on at least the URO graph for the one or more resource requirements and the URO graph for the one or more resources, wherein the superimposed URO graph is fully connected.

6. The system of claim 5, wherein the at least one processing device is further configured to:
initiate the ant colony optimization (ACO) algorithm on the superimposed URO graph, wherein initiating further comprises:
traversing, iteratively, the superimposed URO graph, wherein traversing further comprises traversing one or more paths from the one or more nodes representing the one or more resource requirements to the one or more nodes representing the information associated with the one or more resources; and
generating one or more pheromone trail values for the one or more paths at each iteration.

7. The system of claim 6, wherein the at least one processing device is further configured to:
generate the one or more primary resource selection parameters based on at least the one or more pheromone trail values.

8. The system of claim 7, wherein the one or more primary resource selection parameters comprises at least path preference parameters, exposure preference parameters, and resource preference parameters.

9. The system of claim 7, wherein the at least one processing device is further configured to:
generate one or more secondary resource selection parameters based on at least the one or more pheromone trail values;
transmit the one or more secondary resource selection parameters to a computing device associated with a subject matter expert (SME);
electronically receive, from the computing device associated with the SME, one or more SME inputs based on at least the one or more secondary resource selection parameters; and
determine, using the fuzzy resource selection engine, the one or more resources in the descending order of applicability for the one or more resource requirements based on at least the one or more primary resource selection parameters and the one or more SME inputs.

10. A computer program product for cognitive resource identification using swarm intelligence, the computer program product comprising a non-transitory computer-readable medium comprising code causing a first apparatus to:
electronically receive, from a computing device of a user, one or more resource requirements associated with an entity;
electronically receive metadata associated with one or more resources;
generate a superimposed unified resource ontological (URO) graph based on at least the one or more resource requirements and the metadata associated with the one or more resources;
initiate an ant colony optimization (ACO) algorithm on the superimposed URO graph;
generate, using the ACO algorithm, one or more primary resource selection parameters based on at least initiating the ACO algorithm on the superimposed URO graph;
initiate a fuzzy resource selection engine on the one or more primary resource selection parameters;
determine, using the fuzzy resource selection engine, the one or more resources in a descending order of applicability for the one or more resource requirements based on at least the one or more primary resource selection parameters; and
transmit control signals configured to cause the computing device of the user to display the one or more resources in the descending order of applicability to the one or more resource requirements.

11. The computer program product of claim 10, wherein the first apparatus is further configured to:
determine one or more exposure requirements associated with the entity;
initiate one or more machine learning algorithms on the one or more resource requirements and the one or more exposure requirements; and
generate a URO graph for the one or more resource requirements, wherein the URO graph for the one or more resource requirements comprises one or more nodes representing the one or more resource requirements and one or more edges representing the one or more exposure requirements.

12. The computer program product of claim 11, wherein the first apparatus is further configured to:
electronically receive metadata associated with the one or more resources, wherein the metadata further comprises at least one or more exposure factors associated with the one or more resources, one or more dependencies associated with the one or more resources, and one or more data leakages associated with the one or more resources.

13. The computer program product of claim 12, wherein the first apparatus is further configured to:
initiate the one or more machine learning algorithms on the metadata associated with the one or more resources; and
generate a URO graph for the one or more resources, wherein the URO graph for the one or more resources comprises one or more nodes representing information associated with the one or more resources, and one or more edges representing the one or more exposure factors associated with each of the one or more resources, the one or more dependencies associated with each of the one or more resources, and the one or more data leakages associated with each of the one or more resources.

14. The computer program product of claim 13, wherein the first apparatus is further configured to:
generate the superimposed URO graph based on at least the URO graph for the one or more resource requirements and the URO graph for the one or more resources, wherein the superimposed URO graph is fully connected.

15. The computer program product of claim 14, wherein the first apparatus is further configured to:
initiate the ant colony optimization (ACO) algorithm on the superimposed URO graph, wherein initiating further comprises:
traversing, iteratively, the superimposed URO graph, wherein traversing further comprises traversing one or more paths from the one or more nodes representing the one or more resource requirements to the one or more nodes representing the information associated with the one or more resources; and
generating one or more pheromone trail values for the one or more paths at each iteration.

16. The computer program product of claim 15, wherein the first apparatus is further configured to:
generate the one or more primary resource selection parameters based on at least the one or more pheromone trail values.

17. The computer program product of claim 16, wherein the one or more primary resource selection parameters comprises at least path preference parameters, exposure preference parameters, and resource preference parameters.

18. The computer program product of claim 16, wherein the first apparatus is further configured to:
generate one or more secondary resource selection parameters based on at least the one or more pheromone trail values;
transmit the one or more secondary resource selection parameters to a computing device associated with a subject matter expert (SME);
electronically receive, from the computing device associated with the SME, one or more SME inputs based on at least the one or more secondary resource selection parameters; and
determine, using the fuzzy resource selection engine, the one or more resources in the descending order of applicability for the one or more resource requirements based on at least the one or more primary resource selection parameters and the one or more SME inputs.

19. A method for cognitive resource identification using swarm intelligence, the method comprising:
electronically receiving, from a computing device of a user, one or more resource requirements associated with an entity;
electronically receiving metadata associated with one or more resources;
generating a superimposed unified resource ontological (URO) graph based on at least the one or more resource requirements and the metadata associated with the one or more resources;
initiating an ant colony optimization (ACO) algorithm on the superimposed URO graph;
generating, using the ACO algorithm, one or more primary resource selection parameters based on at least initiating the ACO algorithm on the superimposed URO graph;
initiating a fuzzy resource selection engine on the one or more primary resource selection parameters;
determining, using the fuzzy resource selection engine, the one or more resources in a descending order of applicability for the one or more resource requirements based on at least the one or more primary resource selection parameters; and
transmitting control signals configured to cause the computing device of the user to display the one or more resources in the descending order of applicability to the one or more resource requirements.

20. The method of claim 19, wherein the method further comprises:
determining one or more exposure requirements associated with the entity;
initiating one or more machine learning algorithms on the one or more resource requirements and the one or more exposure requirements; and
generating a URO graph for the one or more resource requirements, wherein the URO graph for the one or more resource requirements comprises one or more nodes representing the one or more resource requirements and one or more edges representing the one or more exposure requirements.
